(19) United States
(12) Patent Application Publication
(10) Pub. No.: US 2009/0312953 A1
(43) Pub. Date: Dec. 17, 2009

(54) Mitigation of Nonlinear Background Radiation During Real Time Radiation Monitoring of Containers at a Quayside Crane

(75) Inventor: Eugene Yamamoto, Corona del Mar, CA (US)

Correspondence Address: FOLEY & LARDNER LLP, 975 PAGE MILL ROAD, PALO ALTO, CA, 94304, US

(73) Assignee: VeriTainer Corporation

(21) Appl. No.: 12/141,025

(22) Filed: Jun. 17, 2008

(51) Int. Cl. G06F 19/00; G01N 23/00; G01T 1/00

(52) U.S. Cl. 702/22; 378/57; 250/395

(57) ABSTRACT

Dynamic background radiation is mitigated during crane hoisted transport at a quayside crane of a container along a transport path. A background distribution for the background radiation along the transport path is developed. Concurrently with the crane hoisted transport of the container along the transport path radiation data from each of a plurality of detectors disposed in a spatially fixed relationship to the container is obtained. The radiation data in conjunction with positionally commensurate background distribution, can then be analyzed. From such analysis, a positive determination or a negative determination of the radioactive material being present in the container can then made.

### RELATED APPLICATION DATA

In Alioto, et al, Radiation Detection Unit for Mounting a Radiation Sensor to a Container Crane, application Ser. No. 11/605,529 (the '529 application); Alioto, et al, Real Time System for Monitoring Containers from a Quayside Crane, application Ser. No. 11/605,530 (the '530 application); Alioto et al., Container Crane Radiation Detection Systems and Methods, U.S. Pat. No. 6,768,421 (the '421 patent); Alioto et al., “Apparatus and Method for Detecting Radiation and Radiation Shielding in Containers,” U.S. Pat. No. 7,026,944 (the '944 patent); and Alioto et al., “Inverse Ratio of Gamma-Ray and Neutron Emissions in the Detection of Radiation Shielding of Containers,” U.S. Pat. No. 7,116,235 (the '235 patent), new and useful apparatuses and methods useful in and for radiation scanning of shipping containers are described. The '529 application, the '530 application, the '421 patent, the '944 patent and the '235 patent are incorporated by reference as though fully set forth herein.

### BACKGROUND OF THE INVENTION

1. Field of the Invention

The present invention relates generally to detection of radioactive material within shipping containers concurrently with the crane hoisted transport of such containers and, more particularly, to mitigation of nonlinear background radiation present during the real time detection of radiation about such containers.

2. Description of the Related Art

As generally described in the '421, '944 or '235 patents incorporated herein, the presence of radioactive material in shipping containers may be determined through the detection of radiation counts or energy, typically of gamma rays and neutrons, existing about the container and analyzing radiation data derived from the detected radiation. If the analysis determines that an anomaly from the normally existing radiation about the container exists, there is an indication that the container may contain radioactive material even if an attempt has been made to shield the presence of such radioactive material by use of a radiation absorbent material.

In the '529 application, a particular embodiment of a radiation detection unit specifically adapted for use on a quayside crane is described. For purposes of the present specification, the term detector shall, without limitation, include any type of radiation detection unit as described in the '529 application or any other known radiation detector or radiation sensor.

Also as generally described in the '421, '944 or '235 patents, the detectors are mounted to a hoist attachment of a quayside crane so that such detectors remain in a spatially fixed spaced apart relationship to the container during its crane hoisted transport along a transport path, exemplarily a between a top wharfage and container ship. By maintaining the detectors in this spatially fixed spaced apart relationship, the detectors measure primarily radiation that naturally occurs in the environment about the container.

Exemplarily, as described in any of the '421, '944 and '235 patents, (1) gamma rays that exist about a shipping container are detected and counted (“gamma count”); (2) the energy level of those detected and counted gamma rays is measured (“gamma energy”); and (3) neutrons that exist about a container may also detected and counted (“neutron count”). These three data points, i.e., gamma count, gamma energy and neutron count, can then be analyzed to determine, within acceptable limits, if the container currently under crane hoisted transport contains a radioactive material and, if so, can further identify the radioactive material inside this container or if radiation absorbent material is present for the purposes of possibly shielding radioactive material.

As described in the '944 and '235 patents, the sources of the detected gamma rays and neutrons considered of interest are all of those as naturally occurring in the natural environment of soil, water and atmosphere. Particularly as described in the '944 patent, normalization of radiation fingerprints is performed during the scanning of the containers, to remove substantially the influence of the naturally occurring radiation so that a “fingerprint,” as such term is defined therein, of the container is obtained. If a heuristic match is made between the container fingerprint and a fingerprint of a known radioactive material, then a high probability exists that the container currently under inspection contains this material. With respect to the '235 patent, a anomalous change in the ratio of naturally occurring gamma ray radiation to the naturally occurring neutron radiation in the presence of a container is used in the determination of whether a container contains radioactive material or a radiation absorbent material possible shielding radioactive material.

In addition to these sources of background radiation as discussed in the '944 and '235 patents, other possible sources of radiation include radiation emanating from fixed quayside structures, buildings and materials inclusive of vessels and vehicles, laded and unladed cargo whether on ship or land, and the structural material of the container currently under crane hoisted transport and the normal contents within the container. Thus, the radiation exhibits nonlinear dependencies from these additional non-environmental sources. The naturally existing radiation also exhibits dependencies as to time of day and weather conditions. Moreover, during crane hoisted transport of a container the radiation collected at the detectors further depends on various environmental topology such as whether the detectors are located over land, over water or over a ship, giving rise to variable and nonlinear radiation counts and energy dependent on the present spatial location of each of the detectors.

For example, the gamma radiation due to potassium-40, Thorium-232 and its decay daughters and Uranium-238 and its decay daughters are lower over water than over land because the vast majority of these isotopes are present in soil and not water. The neutron counts obtained from any one detector vertically disposed above the hull of a ship are enhanced because of the “ship effect” in which neutrons are produced from the interaction of cosmic rays with the bulk matter of the ship, i.e., the steel in the hull, the cargo containers and their contents. As any detector transitions horizontally, the detected radiation will vary nonlinearly and exhibit discontinuities as such detector transitions over topological boundaries, exemplarily such as between hull, water and wharfage.

It is therefore seen that the omnipresent naturally occurring radiation in the presence of this varying topology and other dependencies gives rise to dynamic background radiation that is variable, nonlinear and discontinuous. The background radiation is dependent on both the position of the detector in three-dimensional space and on time due to naturally occurring time variance of the omnipresent background. This background radiation is further nonlinear and discontinuous due to the topological boundaries between ships, water, and wharfage, among others, and the ever changing position of containers during transport and placement of quayside materials, vessels, vehicles and laded and unladed cargo. As a container is hoisted and transported, the detectors mounted to the hoist attachment accordingly will detect a background distribution of this dynamic background radiation along the transport path.

Accordingly, a need exists to determine this background distribution so that collected radiation data obtained from about a container is analyzed in view of this background distribution.

### SUMMARY OF THE INVENTION

Accordingly, it is a primary object of the present invention to provide methods and apparatuses to mitigate the effect of the nonlinear background radiation in the detection of radioactive materials in containers during crane hoisted transport of such containers.

It is another object of the present invention to determine the background distribution such that the radiation data collected by the detectors during crane hoisted transport of the container can be analyzed in view of this background distribution.

According to one embodiment of the present invention, a method to determine during crane hoisted transport at a quayside crane of a container along a transport path a presence of radioactive material being disposed within the container wherein background radiation along the transport path is dynamic includes steps of developing a background distribution for the background radiation for the transport path, obtaining concurrently with the crane hoisted transport of the container along the transport path radiation data from each of a plurality of detectors disposed in a spatially fixed relationship to the container, and analyzing the radiation data in conjunction with the background distribution. The radiation data and the background distribution being analyzed are positionally commensurate with respect to the transport path. From such analysis, a positive determination or a negative determination of the radioactive material being present in the container can then made.

A feature of the present invention is that the radiation data derived from the detectors can be analyzed with respect to position with the background distribution. As will be seen from the following Description of the Exemplary Preferred Embodiments, the present invention advantageously allows the background distribution to be developed over time from data obtained during crane hoisted transport of containers for which a negative determination of radioactive material being present therein was made.

These and other objects, advantages and features of the present invention will become readily apparent to those skilled in the art from a study of the following Description of the Exemplary Preferred Embodiments when read in conjunction with the attached Drawings and appended Claims.

### BRIEF DESCRIPTION OF THE DRAWING

FIG. 1 is a fore-and-aft view of wharfage, a quayside crane on the top wharfage and a container ship at the side wharfage;

FIG. 2A is a plan view, partially cut away and partially in cross section, of the underside of the spreader of FIG. 1;

FIG. 2B is a cross section of the spreader of FIG. 2A taken along line 2B-2B;

FIG. 3A is a broken perspective view of the container of FIG. 1 showing its corner castings;

FIG. 3B is the container of FIG. 3A showing the twist locks of the spreader of FIG. 2 engaged into the corner castings of FIG. 3A;

FIG. 4 is a computer system useful in practicing the present invention;

FIG. 5 is a flowchart of an exemplary method of the present invention; and

FIG. 6 is a flowchart of a detail of the background distribution developing step of FIG. 5.

### DESCRIPTION OF THE EXEMPLARY PREFERRED EMBODIMENTS

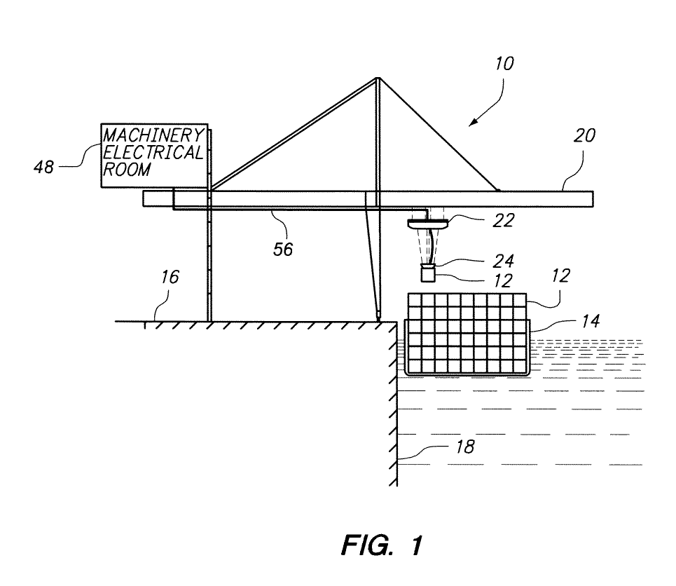

Referring now to FIG. 1, there is shown a typical quayside crane 10 of the type employed for loading or unloading a standardized shipping container 12 to or from a container ship 14 and top wharfage 16 when the container ship 14 is docked at the side wharfage 18 associated with the quayside crane 10. The quayside crane 10 includes a gantry 20, a hoist mechanism (inclusive of a headblock) 22, and a hoist attachment, such as a spreader 24, to grasp the container 12. The spreader 24 is one particular type of hoist attachment that accommodates any size of standard lengths for the container 12.

A container terminal will generally have thereat a plurality of quayside cranes, each similar to the quayside crane 10, wherein each one of several container ships, similar to container ship 14, can be docked at the side wharfage 18 associated with each respective one of the container cranes. Accordingly, each of the shipping containers, each similar to the shipping container 12, in each of the container ships can then be loaded or unloaded, as the case may be, to or from the top wharfage 16.

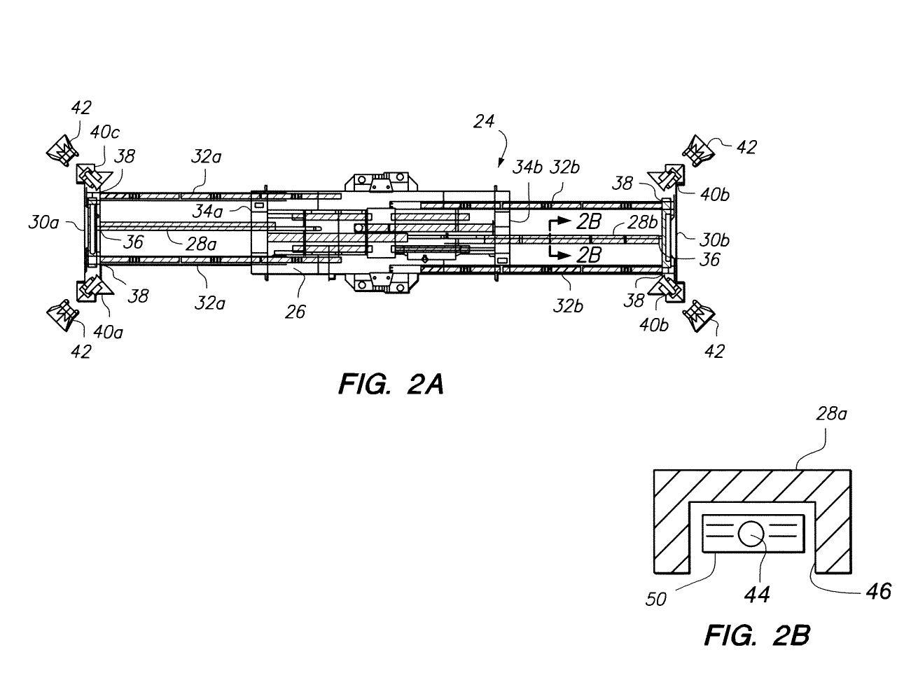

With further reference to FIG. 2A, the spreader 24 includes a main body 26, a pair of actuated drawbars 28ₐ, 28_{b}, a pair of gable ends 30ₐ, 30_{b}, and a first pair of telescoping arms 32ₐ and a second pair of telescoping arms 32_{b}. Each of the drawbars 28ₐ, 28_{b} extends outwardly from a respective opposite end 34ₐ, 34_{b} of the main body 26. Each of the gable ends 30ₐ, 30_{b} is affixed to a distal end 36 transversely of a respective one of the drawbars 28ₐ, 28_{b}. The first pair and said second pair of telescoping arms 32ₐ, 32_{b} are coextensive with a respective one of the drawbars 28ₐ, 28_{b} and extend outwardly from the respective opposite end 34ₐ, 34_{b} of the main body 26. Each of the first pair and the second pair of telescoping arms 32ₐ, 32_{b} also has a distal end 38 attached to a respective one of the gable ends 30ₐ, 30_{b}.

The drawbars 28a, 28b of the spreader 24 are actuated along their length from the main body 26 in opposition to each other to adjust the spreader 24 to accommodate any of the standard lengths of the container 12 to be grasped. Accordingly, in such spreader 24 the telescoping arms 32ₐ, 32_{b} are supported by the main body 26 in slidable engagement therewith. In a fixed length hoist attachment the actuated drawbars 28a, 28b are not present and the telescoping arms 32ₐ, 32_{b} are fixed to the main body 26.

In the hoist attachment or spreader 24, each of the gable ends 30ₐ, 30_{b} includes a pair of hydraulically actuated twist locks 40ₐ, 40_{b}. Each of the twist locks 40ₐ, 40_{b} extends downwardly at a respective lower corner of the gable ends 30ₐ, 30_{b}.

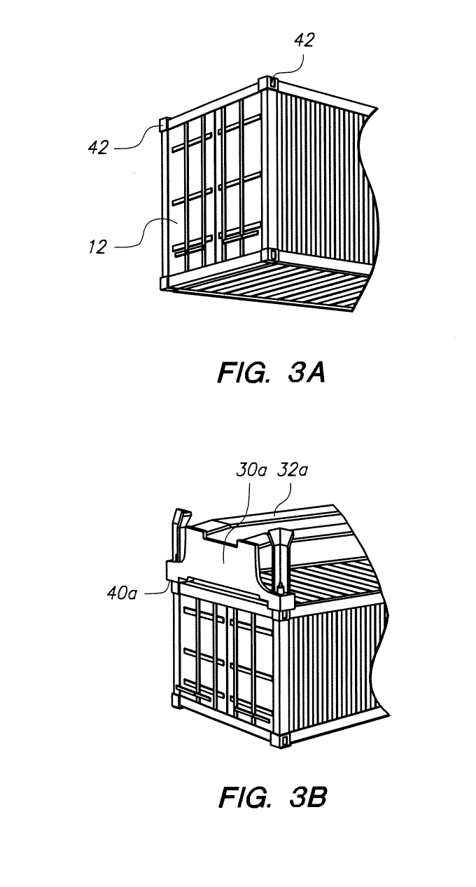

With further reference to FIG. 3A, each of the shipping containers, as seen on the exemplary shipping container 12, has on each of its upper four corners thereof a corner casting 42. Each corner casting 42 is adapted to receive a respective one of the twist locks 40ₐ, 40_{b} in locking engagement.

The twist locks 40ₐ, 40_{b} are “closed” when they are engaged in or twistlocked into the corner castings 12, as best seen in further reference to FIG. 3B. Similarly, the twist locks 40ₐ, 40_{b} are “open” when the twist locks 40ₐ, 40_{b} are disengaged from the corner castings 42 of the container 12, as seen in the exploded view relationship of FIG. 2. Accordingly, the twist locks 40ₐ, 40_{b}, upon closing in cooperative engagement with the corner castings 42, grasp the container 12 thereby mounting it to the hoist attachment or spreader 24 so that it may be hoisted and transported between the container ship 14 and the top wharfage 16, and upon opening release the container 12 from the hoist attachment or spreader 24.

Returning to FIG. 1, the hoist mechanism 22 actuates longitudinally along the gantry 20 so that the hoist mechanism 22 can be vertically positioned above one of the containers 12 for grasping by the hoist attachment or spreader 24, and further so that the container 12 so grasped can be moved between the top wharfage 16 and the container ship 14 for loading or unloading as the case may be. The hoist mechanism 22 further provides vertical actuation of the hoist attachment or spreader 24 so that the hoist attachment or spreader 24 can be dropped into position immediately above one of the containers 12 to be grasped by the twist locks 40ₐ, 40_{b}, lifted for transport of the grasped container 12 between the container ship 14 and the top wharfage 16, and then dropped again for releasing the container 12 from the twist locks 40ₐ, 40_{b} upon the container being placed on the top wharfage 16 or upon another container 12 in the container ship 14.

The above-described operation of the quayside crane 10 is well known and the details of the actuation of the hoist mechanism 22, the draw bars 28ₐ, 28_{b}, and the twist locks 40ₐ, 40_{b} need not be further described herein. It is seen from the forgoing description of the quayside crane 10 that any container 12 from the time it is grasped until it is released can be transported in three dimensional space bi-directionally between the container ship 14 and the top wharfage 16.

Exemplarily, as seen in FIG. 2B, each one of the drawbars 28ₐ, 28_{b} may have a detector 44 mounted thereto within a generally U-shaped channel 46, such as seen in the cross-section of the drawbar 28ₐ, so that the detector 44 does not interfere with the retraction or extension of the drawbar 28ₐ in or out of the main body 26. Similarly, each of the other components of the hoist attachment or spreader 24, i.e., the main body 26, gable ends 30ₐ, 30_{b} or telescoping arms 32ₐ, 32_{b}, may also have U-shaped channels, similar to U-shaped channel 46, in which additional detectors 44 may be mounted to any these components in a similar manner as described to mount the detector 44 to the drawbar 28ₐ. Accordingly, while the container 12 is being grasped by the hoist attachment or spreader 24, the detectors 44 remain disposed in a spatially fixed relationship to the container 12 during the crane hoisted transport at the quayside crane 10 of the container 12 along a bidirectional transport path between the top wharfage 16 and the container ship 12.

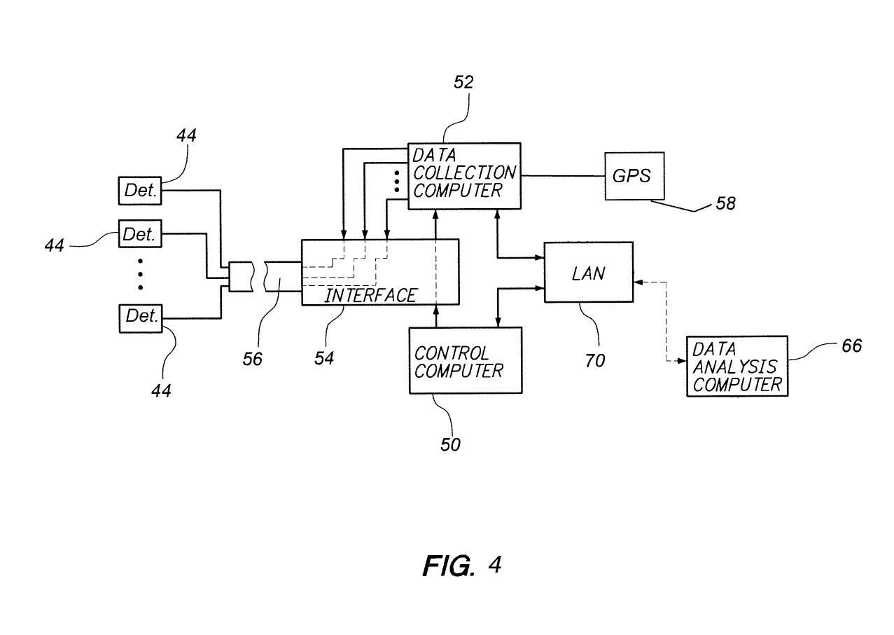

With further reference to FIG. 4, the quayside crane 10 further includes a machinery/electrical room 48 (FIG. 1) in which there is located a control computer 50. a data collection computer 52 and an interface 54. The control computer 50 develops the control signals for the electrical, mechanical and hydraulic devices that provide for the actuation of the hoist mechanism 22 draw bars 28ₐ, 28_{b}, and the twist locks 40ₐ, 40_{b}. The interface 54 provides an interface between low voltage control signals, which signal the respective components of the hoist attachment or spreader 24 that are to be actuated, developed at the control computer 50 and high power currents that are conducted through a baloney cable 56 to such respective components to enable their actuation. The interface 56 may conventionally include relays or other types of high power switches responsive to the low voltage control signals, as described in the '530 application.

During crane hoisted transport of one of the containers 12, the detectors 44 are continuously collecting radiation and developing an output signal commensurate with the collected radiation. The output signal from each of the detectors 44 may also be hard wired communicated, as best seen in FIG. 4, through the baloney cable 56 to the data collection computer 52 whereat such signals are stored as digital radiation data.

As described in the '530 application, the control computer develops a twist lock control signal that controls the actuation of the twist locks 40ₐ, 40_{b} with the data collection computer 52 being cognizant of the twist lock control signal thereby enabling the data collection computer 52 to know when each one of the containers 12 has been engaged and subsequently disengaged by the twist locks 40a, 40b, and also enabling the data collection computer 52 to timestamp such events. Furthermore, the data collection computer 52 can further timestamp data points between these two events, such as periodically. Accordingly, transit time for any one of the containers 12 during its crane hoisted transport along the transport path can also be computed and known.

In addition thereto, because the data collection computer 52 is in communication with the control computer 50, the data collection computer is cognizant of all control signals developed by the control computer 50. For example, one further control signal conveys information as to the position of the drawbars 28a, 28b and/or the telescoping arms 32a, 32b, allowing the data collection computer to know the current one of the containers 12 being hoisted is one of a standard twenty or forty foot length, or some other non-standard length. Yet further control signals developed by the control computer 50 convey information as to the longitudinal position of the hoist mechanism 22 along the gantry 20 and the vertical position of the hoist attachment or spreader 24. Accordingly, from all of these control signals, and from periodic time stamping of the data stored in the data collection computer 52 obtained from these control signals, the position of each one of the detectors 44 in three dimensional space is at all times computable and known at the data collection computer 52. Furthermore, during the crane hoisted transport of any one of the containers 12, its transport path and velocity along the transport path can also be readily computed from this data.

Alternatively, the data collection computer 52 need not be cognizant of the control signals developed by the control computer 50 to determine the above parameters of position in three dimensional space, the transport path and velocity along the transport path. Commercially available global position satellite systems, generally indicated as GPS 58, can also be used to determine these parameters. For example, GPS 58 may monitor the position of the any of the container 12 currently being hoisted, the position of the hoist attachment or spreader 24, or any one of the detectors 44, and data signals indicative of these positions communicated to the data collection computer 52, as best seen in FIG. 4. Time stamping of the position information communicated to the data collection computer 52 may either use the system clock of the data collection computer 52 or the time stamp information provided by GPS 58.

Implementation of GPS 58 may be particularly useful for such cranes installations wherein the container crane 10 (FIG. 1) is manually operated and accordingly does not have any control means similar to the control computer 50 from which the control signals may be obtained to determine the position in three dimensional space and computer the above parameters as described. GPS 58 may also be useful wherein software integration between the data collection computer 52 and the control computer 50 is not possible or otherwise technically prohibitive due to software incompatibilities.

Referring now to FIG. 5, there is shown a flowchart 60 of an exemplary method to determine during the crane hoisted transport at the quayside crane 10 of the container 12 along its transport path a presence of radioactive material being disposed within the container 12 wherein background radiation along the transport path is dynamic. As indicated at step 62, a background distribution for the background radiation, which is to be encountered along the transport path of the current one of the containers 12, is first developed as described in greater detail herein below.

Next, as indicated at step 64, radiation data from each of the detectors 44 is obtained concurrently with the crane hoisted transport of this container 12 as it moves along the transport path. As described above, each of the detectors 44 is disposed in a spatially fixed relationship to this container 12. As the detectors collect radiation data, the signals commensurate with such collected radiation are communicated and stored as the radiation data in the data collection computer 52.

Then, as indicated at step 66, the radiation data is analyzed in conjunction with the background distribution with respect to the transport path. As a result of such analysis, one of a positive determination and a negative determination of radioactive material being present in this container 12 may then be made. The analysis may be performed, as is known from any of the '421, 944 or 235 Patents. Alternatively, as set forth in greater detail below, the analysis may be a comparison of the radiation data to the background distribution. In any event, the analysis may be performed at the data collection computer 52, or at a data analysis computer 68 (FIG. 4) located in the port facility and in communication with the data collection computer 52 over a LAN 70 (FIG. 4) as described in the '530 application.

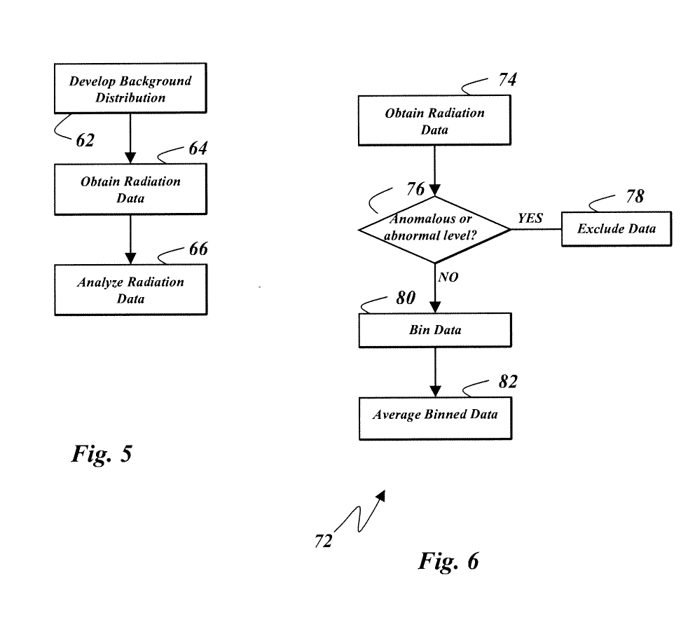

Referring now to FIG. 6, there is shown a flowchart 72 of an exemplary method to develop the background distribution. As indicated at 74, radiation data is obtained during the crane hoisted transport at the quayside crane 10 for each one of a succession of containers 12. It is to be noted the radiation data obtained for each one of these containers 16 may be analyzed in accordance with the analyzing step 66 described above. In such event, there would need to be a prior background distribution developed as indicated at step 62. At least a first container with no or known contents may be used and its radiation data used as the background distribution developed as herein below described.

If a determination is made, as indicated at 76, that the result of the analysis step 66 indicates the container 12 for which the radiation data is currently being obtained contains an anomalous or abnormal count or energy level of radioactivity, then such data is excluded from the background distribution development, as indicated at 78.

Otherwise, as indicated at 80, the radiation currently being obtained is binned. Radiation data is binned with respect to empirical parameters upon which the radiation data obtained exhibits dependence. For example, if discontinuities in either gamma ray or neutrons counts are identified in the radiation data, the data may be binned between these discontinuities. The discontinuities may exemplarily arise from the detectors 44 being over the top wharfage 16, the container ship 12 or the water there between, as described above. Other dependencies that the radiation may be binned for include the length of the hoisted container 12, a position of the container 12 along at least one axis of the transport path or time. As described above, the data collection computer is cognizant of the raw data as developed by the control computer from which container length, position and time are readily computed.

Once the radiation data has been binned, it is averaged with the binned radiation data obtained from previous hoists of prior ones of the containers 12, as indicated at 82. The current binned radiation data may be weighted averaged with the existing binned radiation data for each bin having a common dependency. This weighted average is the background distribution.

It is accordingly seen that the background distribution is accordingly current for each container 12 that is being hoisted. As the sources and/or locations of background radiation change over time, the background distribution, through the weighted average of each bin, will mitigate the effects of the dynamically changing background. The binning of radiation data and developing of the background distribution in accordance with certain dependencies allows the current radiation data to be analyzed with each of these dependencies accounted for in a comparison of the current radiation data to the background distribution.

Furthermore, in addition to the radiation data obtained being binned, the output of the analyses performed on such radiation data is also binned. A comparison of the response of the analysis algorithm used for the baseline of the data obtained for the current container 12 may be made to determine if the current container 12 exhibits features that are anomalous. Accordingly, a comparison is made to the background to determine the features of the container 12, as opposed to known techniques in which background is subtracted.

In the broadest aspect, the principles of the present invention may be applied to any system in which radiation detection of moving objects is required wherein such detection occurs against a dynamic background. The radiation data of a succession of such objects is obtained from the detectors, similar to detectors 44, which are otherwise disposed in a fixed spaced apart relation ship to the objects. Similarly as described above, the radiation data obtained for each of the objects is binned with respect to empirical parameters upon which the radiation data obtained exhibits dependence and the binned radiation combined for each one of the parameters into a canonical average.

Next, radiation is obtained for a further one of the objects, also from the detectors similarly disposed in a fixed spaced apart relation ship to the further one of the objects. As described above, the radiation data of the further one of the objects wherein such radiation data for this further object exhibits dependence on one the identified parameters is analyzed in conjunction with the canonical average binned data that has a dependence on the same one of the parameters. In this broadest embodiment of the present invention, the determination made is whether the radiation data of the further one of the objects is substantially commensurate with the canonical average binned data or anomalous thereto. The analyzing may be a comparison between the radiation data for the further object and the canonical average binned data.

As the radiation data of the succession of objects is being obtained, the binned radiation data for a current one of the objects is weighted averaged with corresponding binned radiation data from prior ones of the succession of objects. However, if the radiation data of this current one of the objects when analyzed in conjunction with said canonical average binned radiation data results in anomaly being determined, then the data from this particular object may be excluded form the weighted average.

In the binning of the radiation data, a discontinuity in a selected one of gamma ray count and neutron count in the radiation data of the succession of the objects is identified. This radiation data for the succession of objects is binned between each such discontinuity.

For example, at least one dimension common to the succession of the objects may be identified. The radiation data may then be binned in accordance with this dimension for the objects.

In another example of binning, a position dependence of the radiation data of the succession of objects may be computed. The position dependence may further be along one axis of a transport path. The radiation data of the succession of objects is thus binned with respect to this axis.

In yet another example of binning, a time dependence of the radiation data of the succession of objects may be computed. 26. The radiation data of the succession of the objects is binned with respect to this time dependence.

There have been described hereinabove novel apparatuses and methods to establish real time domain awareness of the container shipping terminals and to monitor and analyze the radioactive material content, if any, of the containers loaded and unloaded at those terminals. Those skilled in the art may now make numerous uses of and departures from the hereinabove described embodiments without departing from the inventive principles disclosed herein. Accordingly, the present invention is to be defined solely by the lawfully permissible scope of the appended Claims.

What is claimed as the invention is:

1. A method to determine during crane hoisted transport at a quayside crane of a container along a transport path a presence of radioactive material being disposed within said container wherein background radiation along said transport path is dynamic, said method comprising steps of:
developing a background distribution for said background radiation for said transport path;
obtaining concurrently with said crane hoisted transport of said container along said transport path present radiation data from at least one detector disposed in a spatially fixed relationship to said container; and
analyzing said present radiation data in conjunction with said background distribution with respect to said transport path such that one of a positive determination and a negative determination of said radioactive material being present in said container is made.

2. A method as set forth in claim 1 wherein said developing step includes the steps of:
obtaining radiation data during crane hoisted transport of at least one prior container at said quayside crane for which said analyzing step returned said negative determination; and
binning said radiation data obtained during crane hoisted transport of said prior container with respect to empirical parameters upon which said radiation data obtained during crane hoisted transport of said prior container exhibits dependence wherein said analyzing step is performed with respect to said present radiation data that exhibits dependence upon one of said parameters in conjunction with said binned radiation data that exhibits dependence said one of said parameters.

3. A method as set forth in claim 2 wherein said binning step identifies a discontinuity in a selected one of gamma ray count and neutron count in said radiation data obtained during crane hoisted transport of said prior container, said radiation data obtained during crane hoisted transport of said prior container being binned between each such discontinuity.

4. A method as set forth in claim 2 wherein said binning step identifies a length of said prior container, said radiation data obtained during crane hoisted transport of said prior container being binned in accordance with said length.

5. A method as set forth in claim 2 wherein said binning step computes a position dependence of said radiation data obtained during crane hoisted transport of said prior container along at least one axis of said transport path, said radiation data obtained during crane hoisted transport of said prior container being binned with respect to said axis.

6. A method as set forth in claim 2 wherein said binning step computes a time dependence of said radiation data obtained during crane hoisted transport of said prior container, said radiation data obtained during crane hoisted transport of said prior container being binned with respect to said time dependence.

7. A method as set forth in claim 1 wherein said developing step includes the steps of:
obtaining radiation data during crane hoisted transport of a plurality of prior containers at said quayside crane for which said analyzing step returned said negative determination;
binning said radiation data obtained during crane hoisted transport of each one of said prior containers with respect to empirical parameters upon which said radiation data obtained during crane hoisted transport of said prior container exhibits dependence; and
combining said binned radiation data for each one of said parameters into a canonical average.

8. A method as set forth in claim 7 wherein said binned radiation data for a current one of said prior containers is weighted averaged with corresponding binned radiation data from all other prior containers.

9. A method as set forth in claim 8 wherein said binning step identifies a discontinuity in a selected one of gamma ray count and neutron count in said radiation data obtained during crane hoisted transport of said prior containers, said radiation data obtained during crane hoisted transport of said prior containers being binned between each such discontinuity.

10. A method as set forth in claim 8 wherein said binning step identifies a length of said prior containers, said radiation data obtained during crane hoisted transport of said prior containers being binned in accordance with said length.

11. A method as set forth in claim 8 wherein said binning step computes a position dependence of said radiation data obtained during crane hoisted transport of said prior containers along at least one axis of said transport path, said radiation data obtained during crane hoisted transport of said prior containers being binned with respect to said axis.

12. A method as set forth in claim 8 wherein said binning step computes a time dependence of said radiation data obtained during crane hoisted transport of said prior containers, said radiation data obtained during crane hoisted transport of said prior containers being binned with respect to said time dependence.

13. A method to mitigate the effects of dynamic background radiation during real time scanning of one of a succession containers during crane hoisted transport of said containers along a transport path at a quayside crane comprising steps of:
obtaining radiation data during crane hoisted transport of prior ones of said succession of containers at said quayside crane from a plurality of detectors disposed in a spatially fixed spaced apart relationship to said one of said containers;
binning said radiation data obtained during crane hoisted transport of each one of said prior containers with respect to empirical parameters upon which said radiation data obtained during crane hoisted transport of said prior container exhibits dependence;
combining said binned radiation data for each one of said parameters into a canonical average;
obtaining radiation data during crane hoisted transport of said one of said containers; and
analyzing said radiation data having a dependence on one of said parameters in conjunction with said canonical average binned radiation data having a dependence on said one of said parameters such that one of a positive determination and a negative determination of a radioactive material being present in said container is made.

14. A method as set forth in claim 13 wherein said binned radiation data for a current one of said prior ones of said containers is weighted averaged with corresponding binned radiation data from all other prior ones of said containers.

15. A method as set forth in claim 13 wherein said binning step identifies a discontinuity in a selected one of gamma ray count and neutron count in said radiation data obtained during crane hoisted transport of said prior ones of said containers, said radiation data obtained during crane hoisted transport of said prior ones of said containers being binned between each such discontinuity.

16. A method as set forth in claim 13 wherein said binning step identifies a length of said prior one of said containers, said radiation data obtained during crane hoisted transport of said prior ones of said containers being binned in accordance with said length.

17. A method as set forth in claim 13 wherein said binning step computes a position dependence of said radiation data obtained during crane hoisted transport of said prior ones of said containers along at least one axis of said transport path, said radiation data obtained during crane hoisted transport of said prior ones of said containers being binned with respect to said axis.

18. A method as set forth in claim 13 wherein said binning step computes a time dependence of said radiation data obtained during crane hoisted transport of said prior ones of said containers, said radiation data obtained during crane hoisted transport of said prior ones of said containers being binned with respect to said time dependence.

19. A method as set forth in claim 13 wherein said analyzing step includes comparing said radiation data obtained during crane hoisted transport of said one of said containers with said canonical average binned radiation data.

20. A method as set forth in claim 13 further comprising the step of excluding said radiation data obtained during crane hoisted transport of one of said prior ones of said succession of containers from said binning step and said combining step in the event said radiation data obtained for said one of said prior ones of said succession of containers when analyzed in conjunction with said canonical average binned radiation data results in said positive determination that said one of said prior one of said containers contains said radioactive material.

21. A method to mitigate the effects of dynamic background radiation during real time scanning of objects while said objects are in motion, said method comprising steps of:
obtaining radiation data of each one of a succession of said objects from a plurality of detectors disposed in a spatially fixed spaced apart relationship to each of said objects;
binning said radiation data obtained for each one of said objects with respect to empirical parameters upon which said radiation data obtained exhibits dependence;
combining said binned radiation data for each one of said parameters into a canonical average;
obtaining radiation data of a further one of said objects from said plurality of detectors disposed in a spatially fixed spaced apart relationship to said further one of said objects; and
analyzing said radiation data of said further one of said objects having a dependence on one of said parameters in conjunction with said canonical average binned radiation data having a dependence on said same one of said parameters to determine whether said radiation data of said further one of said objects is one of being substantially commensurate with said canonical average binned radiation data and being anomalous to said canonical average binned radiation data.

22. A method as set forth in claim 21 wherein said binned radiation data for each one of said succession of said objects is weighted averaged with corresponding binned radiation data from other prior ones of said succession of objects.

23. A method as set forth in claim 21 wherein said binning step identifies a discontinuity in a selected one of gamma ray count and neutron count in said radiation data of said succession of said objects, said radiation data of said succession of said objects being binned between each such discontinuity.

24. A method as set forth in claim 21 wherein said binning step identifies a at least one dimension common to said succession of said objects, said radiation data of said succession of said objects being binned in accordance with said dimension.

25. A method as set forth in claim 21 wherein said binning step computes a position dependence of said radiation data of said succession of said objects along at least one axis of a transport path, said radiation data of said succession of said objects being binned with respect to said axis.

26. A method as set forth in claim 21 wherein said binning step computes a time dependence of said radiation data obtained of said succession of said objects, said radiation data of said succession of said objects being binned with respect to said time dependence.

27. A method as set forth in claim 21 wherein said analyzing step includes comparing said radiation data of said further one of said objects with said canonical average binned radiation data.

28. A method as set forth in claim 21 further comprising the step of excluding said radiation data of one of said succession of said objects from said binning step and said combining step in the event said radiation data obtained for said one of said succession of objects when analyzed in conjunction with said canonical average binned radiation data results said anomaly being determined.

29. A method as set forth in claim 13 wherein said binned radiation data for a current one of said succession of said objects is weighted averaged with corresponding binned radiation data from all other prior ones of said succession of objects.
